(19) United States
(12) Patent Application Publication
(10) Pub. No.: US 2011/0318164 A1
(43) Pub. Date: Dec. 29, 2011

(54) EXHAUST GAS TURBOCHARGER

(75) Inventors: Adrian Kopp, Kirchdorf (CH); Christoph Häge, Wettingen (CH); Martin Thiele, Remigen (CH)

(73) Assignee: ABB Turbo Systems AG, Baden (CH)

(21) Appl. No.: 13/167,341

(22) Filed: Jun. 23, 2011

Related U.S. Application Data
(63) Continuation of application No. PCT/EP2009/067296, filed on Dec. 16, 2009.

(30) Foreign Application Priority Data
Dec. 23, 2008 (EP) 08172733.1

(51) Int. Cl. F04D 29/12; F02B 39/14; F16J 15/40

(52) U.S. Cl. 415/113; 60/605.3; 415/231

(57) ABSTRACT

The means of sealing the compressor wheel with respect to the bearing housing includes an annular sealing element which forms a sealing boundary face with a shaft edge and to which a spring force is applied in the direction of the shaft edge. The external spring force neither compensates or amplifies the pressure forces acting on the sealing element, irrespective of the direction of the difference in pressure. As a result, the sealing of the oil space in the bearing housing of the exhaust gas turbocharger with respect to the shaft is not influenced, or is influenced only to a small degree, by the pressure fluctuations in the wheel back space of the compressor.

### RELATED APPLICATIONS

This application claims priority as a continuation application under 35 U.S.C. §120 to PCT/EP2009/067296, which was filed as an International Application on Dec. 16, 2009 designating the U.S., and which claims priority to European Application 08172733.1 filed in Europe on Dec. 23, 2008. The entire contents of these applications are hereby incorporated by reference in their entireties.

### FIELD

The disclosure relates to the field of supercharged internal combustion engines and to a supercharging device for such an internal combustion engine.

### BACKGROUND INFORMATION

Exhaust gas turbochargers with a turbine in the exhaust section of the internal combustion engine and with a compressor which is mounted upstream of the internal combustion engine can be used to increase the performance of an internal combustion engine. The exhaust gases of the internal combustion engine expand in the turbine and are converted into rotational energy. The rotational energy which is acquired is transferred by a shaft to the compressor which compresses air which is fed to the internal combustion engine. The combustion process and the efficiency of the internal combustion engine can be optimized by using the energy of the exhaust gases to compress the air which is fed to the combustion process in the internal combustion engine.

A known exhaust gas turbocharger is composed of a rotor including a shaft, a compressor wheel and a turbine wheel, flow-guiding housing parts (compressor housing or turbine housing) and of a bearing housing. The shaft is mounted in the bearing housing or in one or more bearings which are lubricated with a lubricant. In order to prevent the lubricant from escaping in the direction of the turbine or compressor, the shaft in the bearing housing has in each case a seal in the direction of the turbine and in the direction of the compressor.

The sealing of an oil space in the bearing housing of the exhaust gas turbocharger with respect to the shaft on the compressor side can be carried out by one or more piston rings. For the sake of simplicity, the sealing by a piston ring will be described below. This piston ring has a slight degree of pre-stress and is clamped in a seat of the bearing housing. As a result of the difference in pressure between the air mass flow, which is compressed by the compressor, and the pressure in the oil space of the bearing housing, the piston ring can be displaced in the direction of the turbine during the operation of the turbocharger. Therefore, the piston ring can grind into a rotating counterpart in the direction of the turbine during the operation of the turbocharger. As a result of this grinding in the piston ring groove, the gap which occurs between the piston ring and the rotating counterpart on the shaft can be reduced and a sealing effect of this piston ring seal can be improved. The grinding in the piston ring occurs until the piston ring is situated on a circumferential stop edge in the seat of the bearing housing.

EP 1 130 220 A2 discloses a rotational seal for sealing a rotating component against a stationary housing by a piston ring which is ground in by rubbing against a rotating part in the axial direction. In order to prevent an excessive amount of grinding away of the piston ring, the housing is provided with a stop which limits a displaceability of the piston ring in the axial direction.

The pressure in the oil space of the bearing housing can be substantially constant, and the oil space of the exhaust gas turbocharger can be at atmospheric pressure as a result of a connection of the oil space to the crank housing of the engine, which crank housing is vented.

In the case of the full load operating mode of the engine, a pressure in the wheel back space of the compressor can be higher than in the oil space of the bearing housing, and a positive pressure difference is present across the sealing element, which is not critical in terms of a possible oil leakage.

In case of a partial vacuum in a wheel back space of the compressor, there can be, in contrast, a negative pressure difference across the sealing element. This can cause lubricant to move into the wheel back space depending on the level of the partial vacuum.

### SUMMARY

An exhaust gas turbocharger is disclosed, comprising: a bearing housing with a central bore, at least one bearing arranged in the bore, a shaft arranged in the bore and mounted in the at least one bearing, and a compressor wheel arranged on the shaft, wherein a gap, which extends from the compressor wheel in the direction of the bearing, is formed between the shaft and bearing housing; and a seal located in the bore between the compressor wheel and the bearing, wherein the seal includes at least one annular sealing element which seal forms a sealing boundary face with an edge which rotates with the shaft, wherein the at least one annular sealing element is arranged substantially parallel to an axial direction of the shaft in such a way that it can be displaced on a seat of the bearing housing; and a spring element for exerting a spring force to act on the at least one annular sealing element in the axial direction with respect to the bearing, wherein the sealing element to which a spring force is applied is arranged in the gap between the shaft and the bearing housing in such a way that in an event of a partial vacuum in a region of the compressor wheel, a force acting on the sealing element, which is caused by a pressure difference across the sealing element, has an axial component that acts in a same direction as the spring force.

### BRIEF DESCRIPTION OF DRAWINGS

Embodiments of the exhaust gas turbocharger according to the disclosure are described below with reference to the drawings, in which:

FIG. 1 shows a section through an exhaust gas turbocharger according to the prior art, along the shaft of the exhaust gas turbocharger;

FIG. 2 shows an enlarged detail of the region of the seal of the compressor wheel with respect to the shaft of the exhaust gas turbocharger with an exemplary embodiment of the seal according to the disclosure;

FIG. 3 shows an enlarged detail of the region of the seal of the compressor wheel with respect to the shaft of the exhaust gas turbocharger with an exemplary embodiment of the seal according to the disclosure; and

FIG. 4 shows an enlarged detail of the region of the seal of the compressor wheel with respect to the shaft of the exhaust gas turbocharger according to the embodiment of the seal according to the disclosure in FIG. 2, supplemented with an additional sealing element.

### DETAILED DESCRIPTION

The present disclosure relates to providing a sealing element for sealing the oil space in the bearing housing of the exhaust gas turbocharger with respect to the shaft on the compressor side, which sealing element is not influenced, or is influenced only to a small degree, by the pressure fluctuations in the wheel back space of the compressor.

According to the disclosure, this can be achieved with a sealing element which is held in a desired position by an external force. This force can be applied to the sealing element by one or more spring elements. The pressure forces which act on the sealing element can either be compensated or amplified by the external force, depending on a direction of the difference in pressure.

The sealing element can be embodied as a sealing ring which is seated in a displaceable fashion in a seat of the bearing housing. A gap, in which a sealing ring, to which a spring force is applied, is arranged between the shaft and the bearing housing. The sealing ring can be pushed, according to the disclosure, in the direction of the turbine by a spring element which acts on a first end side, for example by a spring, by spring packets, by elastomers or by externally fed-in compressed air acting on the sealing ring. With an end side lying opposite, the sealing ring can bear on an edge of the shaft or on an edge of an auxiliary component which rotates with the shaft, as a result of which the sealing ring grinds in on this edge during operation. The grinding in can be limited in the axial direction by virtue of the fact that it occurs until the sealing ring bears against a stop. The stop can be embodied here as a positively locking boundary in the form of an axial stop or as a frictionally locking boundary in the form of a widening seat.

In the event of a partial vacuum in the region of the wheel back space, a pressure difference builds up across the sealing ring and applies a force to the sealing ring, wherein this force and the spring force act in the same direction.

In a full load operating mode of an engine, the pressure in the wheel back space of the compressor can be higher than in the oil space of the bearing housing, and consequently a positive pressure difference, which counteracts the external force acting on the sealing element, can be present across the sealing element. So that complete compensation of the external force can be avoided, the force is selected to have a larger value than a compression force which occurs as a result of the maximum positive pressure difference be expected during operation.

Because the positive pressure difference reaches a relatively large absolute value, an effective area of the sealing ring in the direction of the wheel back space of the compressor can be made smaller than an effective area of the sealing ring in the direction of the oil space of the bearing housing. Such optimization of a surface area ratio can allow the sealing effect of the sealing element to be additionally improved.

The ring can also be additionally sealed in order to produce a better sealing effect. In this case, the sealing of the seat in the bearing housing with respect to the ring can be carried out with an elastic element which is either arranged in a groove in a seat of the ring or in a groove in the seat of the bearing housing.

The sealing ring in the seat of the bearing housing can optionally be secured against rotation by a frictionally locking or a positively locking connection of the sealing ring to the bearing housing.

The seal according to the disclosure can be supplemented with a further sealing element, for example, a known piston ring.

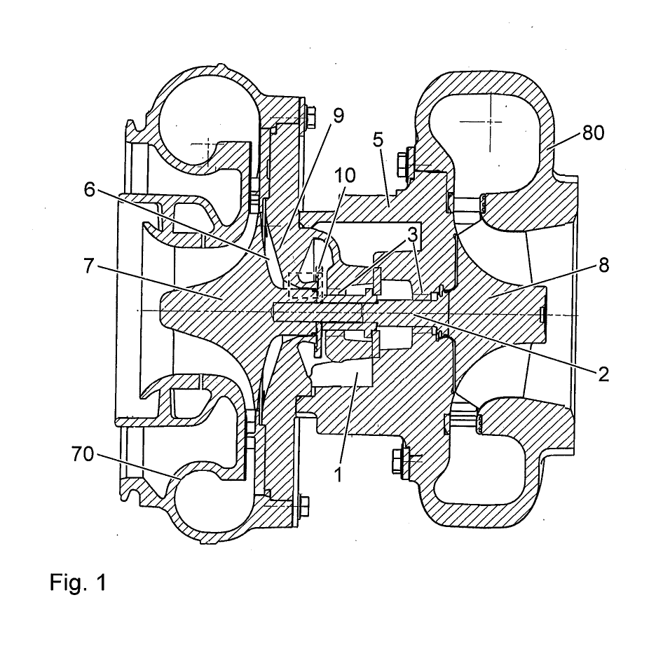

FIG. 1 shows a known exhaust gas turbocharger with a turbine 8 and a compressor 7. An impeller wheel of the turbine is arranged in the turbine housing 80 and in the illustrated embodiment the flow against the impeller wheel occurs obliquely with respect to a radial direction (mixed-flow turbine). An impeller wheel of the compressor is arranged in a compressor housing 70. The two impeller wheels are connected to one another via a common shaft 2. The shaft is mounted in a bearing housing 5 in a plurality of bearings 3. In the region of the bearings 3 of the shaft 2, the bearing housing 5 includes a cavity, which will be referred to as oil space 1. In the oil space 1, the lubricating oil is fed to the bearings or discharged therefrom, and there is a circulation of air saturated with oil. The housing includes two bearing housing components. A first bearing housing component 9 is arranged between the flow duct of the compressor and the oil space 1. A second bearing housing component 5 is arranged between the flow duct of the turbine and the oil space. A cavity, which will be referred to as wheel back space 6, extends in the back of the impeller wheel of the compressor 7, between the impeller wheel and the bearing housing 9.

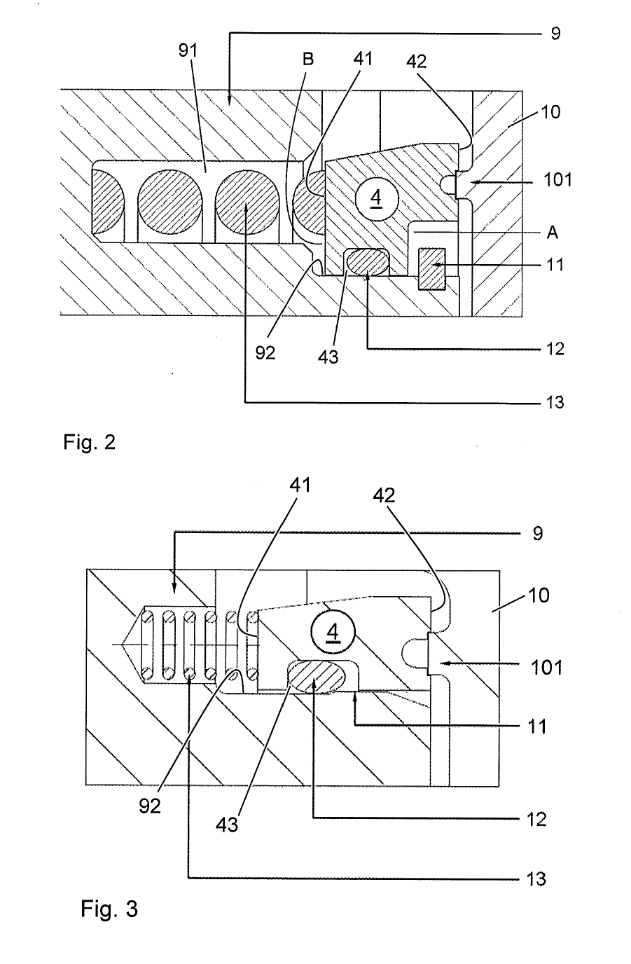

The sealing of the wheel back space 6 with respect to the oil space 1 of the bearing housing, according to the disclosure will be explained below on the basis of the detailed illustrations in FIGS. 2 to 4. The detailed illustrations each show in enlarged form a region between the wheel back space 6 and bearing 3 which is marked by a dashed rectangle in FIG. 1.

The detail according to FIG. 2 shows the bearing housing 9 and a disk 10 which is arranged on the shaft and rotates with the shaft. A gap is formed between the non-rotating bearing housing 9 and the rotating disk 10. The sealing element in the form of a circumferential sealing ring 4 is arranged in the gap. The sealing of the gap by a sealing ring 4 is carried out here, on an inside of the sealing ring with respect to a seat 92 on the bearing housing and, with respect to a protruding edge 101 on the disk 10. The edge 101 can also be embodied as an outer edge of the disk 10 or else as a projecting or externally located edge on the shaft itself. Opposite the edge 101, the sealing ring 4 has an end side 42 which forms a sealing boundary face together with the edge 101. During operation, grinding in of the sealing ring 4 will occur in the region of the sealing boundary face, for example, the edge 101 will erode away material in the sealing ring 4 and a circumferential groove will be formed, as indicated in the figure.

According to the disclosure, a spring force can be applied to the sealing ring 4 and presses the sealing ring in a direction of the edge 101. In the illustrated embodiment, the spring force is applied to the sealing ring 4 by a spring 13 which is mounted in a circumferential bore 91 in the bearing housing 9. Instead of a spring with a large diameter, it is possible, as is indicated in the embodiment according to FIG. 3, for a plurality of small springs along a circumference of the sealing ring 4 to provide the spring force in the direction of the edge 101. As an alternative to simple springs, spring packets or elastomers can also be used, or a corresponding force can be applied to the sealing ring by compressed air which is fed in from outside this region.

In an exemplary embodiment, the sealing ring 4 can be sealed radially toward the inside with respect to the seat 92 on the bearing housing 9 when there is an additional sealing element 12. The additional sealing element 12 can be located in a groove 43 in the sealing ring 4 or in a groove in the bearing housing.

In order to limit the axial displaceability of the sealing ring 4 on the seat 92 of the bearing housing 9 and therefore the grinding-in process described above, a stop 11 can optionally be provided. In the embodiment according to FIG. 2, a positively locking axial stop can be provided, for example, in the form of a circlip, which is guided in a circumferential groove in the seat 92 of the bearing housing 9. In contrast, in the embodiment according to FIG. 3, a conical shape of the seat 92 can ensure a frictionally locking stop. The sealing ring 4 is pushed onto a conical seat in the direction of the edge 101 until it engages in a frictionally locking fashion.

During operation, the sealing ring 4 can additionally be pressed away in the direction of the spring force, toward the edge 101 or else counter to the direction of the spring force, away from the edge 101, depending on the pressure ratio in the gap on the two sides lying opposite one another. By suitable selection of a strength of the spring force it can be possible to prevent the sealing ring 4 becoming detached from the edge 101 in the region of the sealing boundary face in the latter case.

In the full load operating mode of the engine, there can be a higher pressure in the wheel back space 6 of the compressor 7 than in the oil space 1 of the bearing housing 5. A positive pressure difference can be present across the sealing ring 4, which pressure difference counteracts the spring force. An oppositely acting, negative pressure difference is present across the sealing element when there is a partial vacuum with respect to the oil space 1 in the wheel back space 6 of the compressor 7.

Such a negative pressure difference can amplify the external spring force acting on the sealing ring 4.

In addition to the strength of the spring force, the shape and arrangement of the sealing ring 4 in the gap between the bearing housing 9 and the disk 10 can also influence to what extent the pressure forces, generated by the pressure drop present across the sealing ring, press the sealing ring in one direction or the other. Because the positive pressure difference reaches a relatively large absolute value, an effective surface area A of the sealing ring 4 in the direction of the compressor 7 can be selected to be smaller than an effective surface area B of the sealing ring 4 in the direction of the oil space 1 of the bearing housing 5.

The sealing ring 4 can be secured against rotation by a frictionally locking or positively locking connection of the sealing ring 4 to the bearing housing 9.

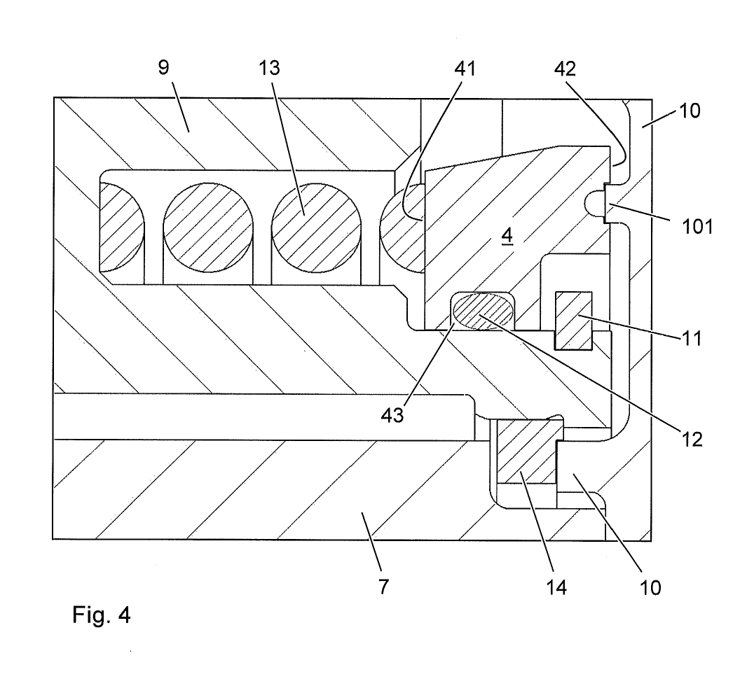

As illustrated in FIG. 4, the seal according to an exemplary embodiment of the disclosure can be supplemented with an additional sealing element in the gap between the fixed housing components and the rotating elements, for example, one or more piston rings 14 between the bearing housing 9 and the compressor wheel 7. The two illustrated sealing elements, the sealing ring 4 and the piston ring 14, both act in the direction of the turbine side but they act in opposite directions in the gap between the fixed housing components and the rotating elements. The gap experiences deflection, wherein the piston ring 14 is arranged before the deflection and the sealing ring 4 is arranged after the deflection.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Oil spaces

2 Shaft

3 Bearings

4 Sealing ring

5 Bearing housing

6 Wheel back space

7 Compressor

70 Compressor housing

8 Turbine

80 Turbine housing

9 Bearing housing

91 Bore in the bearing housing

92 Seat on the bearing housing

10 Disk

101 Edge

11 Stop

12 Sealing element

13 Spring element/elements

14 Piston ring

41, 42 End sides of the sealing ring

43 Groove in the sealing ring

What is claimed is:

1. An exhaust gas turbocharger, comprising:
a bearing housing with a central bore, at least one bearing arranged in the bore, a shaft arranged in the bore and mounted in the at least one bearing, and a compressor wheel arranged on the shaft, wherein a gap, which extends from the compressor wheel in the direction of the bearing, is formed between the shaft and bearing housing; and
a seal located in the bore between the compressor wheel and the bearing, wherein the seal includes at least one annular sealing element which seal forms a sealing boundary face with an edge which rotates with the shaft, wherein the at least one annular sealing element is arranged substantially parallel to an axial direction of the shaft in such a way that it can be displaced on a seat of the bearing housing; and
a spring element for exerting a spring force to act on the at least one annular sealing element in the axial direction with respect to the bearing,
wherein the sealing element to which a spring force is applied is arranged in the gap between the shaft and the bearing housing in such a way that in an event of a partial vacuum in a region of the compressor wheel, a force acting on the sealing element, which is caused by a pressure difference across the sealing element, has an axial component that acts in a same direction as the spring force.

2. The exhaust gas turbocharger as claimed in claim 1, wherein the sealing element is used in combination with one or more piston rings.

3. The exhaust gas turbocharger as claimed in claim 1, wherein the gap experiences at least one deflection in an opposite direction, and the sealing element to which the spring force is applied is arranged in the gap section which runs in the opposite direction, with the result that, when there is a partial vacuum in the region of the compressor wheel, the sealing element is pressed in the axial direction with respect to the bearing owing to the partial vacuum.

4 The exhaust gas turbocharger as claimed in claim 3, comprising:
at least one piston ring used in combination with the sealing element.

5. The exhaust gas turbocharger as claimed in claim 1, wherein the spring element is a spring.

6. The exhaust gas turbocharger as claimed in claim 1, comprising:
a stop of the bearing housing for limiting the axial displaceability of the sealing element.

7. The exhaust gas turbocharger as claimed claim 1, comprising:
an elastic element for sealing the sealing element with respect to the seat of the bearing housing.

8. The exhaust gas turbocharger as claimed in claim 1, wherein the sealing element has a smaller contact surface with respect to a gap leading to the compressor than with respect to a gap leading to the bearing.

9. The exhaust gas turbocharger as claimed in claim 2, wherein the spring element is a spring.

10. The exhaust gas turbocharger as claimed in claim 3, wherein the spring element is a spring.

11. The exhaust gas turbocharger as claimed in claim 2, comprising:
a stop of the bearing housing for limiting the axial displaceability of the sealing element.

12. The exhaust gas turbocharger as claimed in claim 3, comprising:
a stop of the bearing housing for limiting the axial displaceability of the sealing element.

13. The exhaust gas turbocharger as claimed in claim 4, comprising:
a stop of the bearing housing for limiting the axial displaceability of the sealing element.

14. The exhaust gas turbocharger as claimed in claim 4, comprising:
an elastic element for sealing the sealing element with respect to the seat of the bearing housing.

15. The exhaust gas turbocharger as claimed in claim 3, comprising:
an elastic element for sealing the sealing element with respect to the seat of the bearing housing.

16. The exhaust gas turbocharger as claimed in claim 4, comprising:
an elastic element for sealing the sealing element with respect to the seat of the bearing housing.

17. The exhaust gas turbocharger as claimed in claim 2, wherein the sealing element has a smaller contact surface with respect to a gap leading to the compressor than with respect to a gap leading to the bearing.

18. The exhaust gas turbocharger as claimed in claim 2, wherein the sealing element has a smaller contact surface with respect to a gap leading to the compressor than with respect to a gap leading to the bearing.

19. The exhaust gas turbocharger as claimed in claim 3, wherein the sealing element has a smaller contact surface with respect to a gap leading to the compressor than with respect to a gap leading to the bearing.

20. An internal combustion engine, comprising:
the exhaust gas turbocharger as claimed in claim 1.
